(19) United States
(12) Patent Application Publication
(10) Pub. No.: US 2023/0012597 A1
(43) Pub. Date: Jan. 19, 2023

(54) CONTROL OF THE DISPENSING OF AN ADHESION-INCREASING AGENT FOR A RAIL VEHICLE

(71) Applicant: KNORR-BREMSE SYSTEME FÜR SCHIENENFAHRZEUGE GMBH, Munich (DE)

(72) Inventors: Ernst HOHMANN, Dachau (DE); Klaus SCHRÖCKER, Munich (DE); Ferenc SZEKELY, Táborfalva (HU); Kurt HASELSTEINER, Mödling (AT)

(21) Appl. No.: 17/782,900

(22) PCT Filed: Nov. 16, 2020
(86) PCT No.: PCT/EP2020/082220

§ 371 Date: Jun. 6, 2022

(30) Foreign Application Priority Data
Dec. 4, 2019 (DE) 10 2019 113 072.6

(51) Int. Cl. B61C 15/10

(52) U.S. Cl. CPC B61C 15/107

(57) ABSTRACT

A device and method control dispensing of adhesion-increasing agent of a rail vehicle. At least one wheel speed sensor and/or wheel acceleration sensor and/or wheel torque sensor measures the wheel speed or wheel rotational speed and/or the wheel acceleration of a particular wheel and/or the wheel torque acting on the wheel. A measuring unit determines the vehicle speed and/or the acceleration in the vehicle longitudinal direction of the entire rail vehicle. A calculation unit ascertains the ratio of the wheel speed or wheel rotational speed of the wheel and the speed of the rail vehicle and/or the ratio of the wheel acceleration and the acceleration in the longitudinal direction of the rail vehicle and/or the ratio between the target torque and the actual torque acting on the wheel; a change in ratio is used to control dispensing of the adhesion-increasing agent.

### CROSS REFERENCE AND PRIORITY CLAIM

This patent application is a U.S. National Phase of International Patent Application No. PCT/EP2020/082220 filed Nov. 16, 2020, which claims priority to German Patent Application No. 10 2019 133 072.6, the disclosure of which being incorporated herein by reference in their entireties.

### FIELD

Disclosed embodiments relate to control of the dispensing of an adhesion-increasing agent on a rail vehicle in order to correspondingly control the dispensing and distribution of an adhesion-increasing agent on the rail before or in the vicinity of wheels.

### BACKGROUND

When rail vehicles with steel wheels run on steel rails, a comparatively low tractive resistance is of great advantage; however, this low resistance of the wheel-rail contact at the same time restricts the capability to accelerate or decelerate a rail vehicle by means of the wheels. Even when the rail is dry, the possible force transmission is limited. When the rail is contaminated, damp or affected by ice, the potential for force transmission is reduced still further. If braking is carried out under such conditions, possibly even full braking or sharp braking, the problem arises that locking of the wheels may have the effect that deceleration cannot take place optimally and also that damage to the wheels may occur.

In the prior art, therefore, rail vehicles are generally equipped with anti-skid systems. These can control the wheel speed, i.e. the speed of an individual wheel or wheelset, in such a way that the available frictional adhesion (factor of the transmissible tangential force in the longitudinal direction of the vehicle to the orthogonally acting wheel load) is used in the best-possible way for driving the vehicle, but also for braking. In many rail vehicles, this anti-skid system is additionally supplemented by application systems for adhesion-increasing agents, such as, for example, sand distributors, in order to dispense adhesion-increasing agents, such as, for example, sand, before or in the vicinity of specific wheels of the rail vehicle. This adhesion-increasing agent improves the frictional adhesion of the wheel in relation to the rail. However, the adhesion-increasing agent does not have to be a solid, but rather can also be a fluid, a gel or a smoke, a mist or an aerosol.

### SUMMARY

Disclosed embodiments to provide improved control of the dispensing of adhesion-increasing agent of a rail vehicle in order to overcome the disadvantages of the prior art.

### BRIEF DESCRIPTION OF THE FIGURES

An exemplary embodiment is explained in more detail below with reference to the accompanying drawings:

FIG. 1 shows, by way of example, a rail vehicle, which is equipped with a system according to the disclosed embodiments for controlling the dispensing of adhesion-increasing agent.

FIG. 2 shows more precisely a calculating unit which is contained in the system for controlling the dispensing of adhesion-increasing agent of a rail vehicle.

### DETAILED DESCRIPTION

A known prior-art document is the specification DE 41 37 546 C2, which comprises a method for determining the running speed of a rail vehicle. For calculating the running speed, the coefficient of adhesion between a wheel of the rail vehicle and a rail is measured. Also disclosed is a microcomputer, by way of which the braking force of the rail vehicle is influenced in such a way as to avoid locking of the wheel.

The known document DE 601 24 993 T2 discloses a sand distributing device for rail vehicles, by way of which sand is sprayed between a wheel and a rail by means of compressed air to prevent slipping. The spray pressure of the compressed air can be varied in dependence on the relative wind.

Another known prior-art document is DE 10 2018 209 920 B3, which is concerned with the moisture on rails and a reduced coefficient of adhesion between rails and wheels of rail vehicles. This document discloses a method for predicting a coefficient of adhesion at a contact point between a rail and a wheel rolling on it, while taking a number of ambient parameters into consideration, such as, for example, the air pressure, the air temperature, the atmospheric humidity.

The devices for dispensing an adhesion-increasing agent serve the purpose that, when there are particularly low frictional adhesion conditions, adhesion-increasing agents can be introduced into the wheel-rail contact, and in this way the coefficient of adhesion can be raised. Consequently, the capability to drive or brake the rail vehicle can be improved. Systems for dispensing adhesion-increasing agents according to the prior art apply constant or speed-dependently specified dispensing rates (that is to say the dispensing of adhesion-increasing agents per unit of time or else per distance covered).

With each wheel that rolls over the discharged adhesion-increasing agent, its effect is reduced. Depending on the contamination of the rail, the available coefficients of adhesion vary greatly and, for example, under the influence of crushed leaves, may reach values below 0.01. On dry rails, the coefficient of adhesion is generally 0.15 or more. Under such conditions, it is then generally not enough to equip one of the front wheels with systems for dispensing adhesion-increasing agent. Therefore, rail vehicles are generally equipped with a number of devices for dispensing adhesion-increasing agent along the vehicle. Due to the constant or speed-dependently specified dispensing rate per unit of time and distance covered, however, the consumption of adhesion-increasing agent per rail vehicle possibly becomes very high, and the coefficient of adhesion cannot be specifically increased at those locations at which it is, for example, particularly necessary. Consequently, in the prior art the dispensing rate cannot be adapted to the frictional adhesion that is present during braking at the wheels along the train.

In such systems, no specific local or individual control of devices for dispensing adhesion-increasing agent is possible at one specific wheel/a number of specific wheels. In the case of such systems, it may, for example, happen that too much adhesion-increasing agent, such as, for example, sand, is dispensed, which considerably increases the consumption of adhesion-increasing agents without sufficiently or specifically raising the frictional adhesion.

Therefore, disclosed embodiments aim to provide improved control of the dispensing of adhesion-increasing agent of a rail vehicle in order to overcome the disadvantages of the prior art by providing an apparatus for controlling the dispensing of adhesion-increasing agent of a rail vehicle and also a method for controlling the dispensing of adhesion-increasing agent of a rail vehicle.

Disclosed embodiments provide an apparatus for controlling the dispensing of adhesion-increasing agent of a rail vehicle with at least one device for dispensing adhesion-increasing agent which is assigned to a wheel and is optionally provided in the vicinity of a wheel of a rail vehicle.

Optionally, the apparatus for dispensing adhesion-increasing agent is located directly before a specific wheel.

The apparatus also comprises at least one wheel speed sensor and/or wheel acceleration sensor, which measures the wheel speed or the rotational speed or the wheel acceleration of a specific wheel, and/or a torque sensor for determining the actual torque acting on the wheel.

The measured wheel acceleration is optionally the angular acceleration of the wheel.

The target torque acting on the wheel is determined depending on the braking system architecture or is taken from it.

Also provided is a measuring unit, which determines the vehicle speed or the acceleration in the longitudinal direction of the vehicle of the entire rail vehicle. A calculating unit is adapted to determine the ratio of the wheel speed or the rotational wheel speed of the wheel and the speed of the rail vehicle and/or the ratio of the wheel acceleration and the acceleration in the longitudinal direction of the rail vehicle and/or the ratio between the target torque acting on the wheel and the actual torque.

At least one of these ratios is considered, in particular how it changes. The control of the dispensing of adhesion-increasing agent by the device for dispensing adhesion-increasing agent takes place on the basis of the changing of this at least one ratio. The dispensing of adhesion-increasing agent by the device for dispensing adhesion-increasing agent is therefore the controlled variable.

This makes it possible to react directly to slipping or a reduction in the frictional adhesion at specific wheels, since adhesion-increasing agent is dispensed onto the rail specifically at these wheels, in order to reduce again the slipping or the reduction in the frictional adhesion.

Optionally, not only one wheel, but a number of wheels are taken into consideration for controlling the dispensing of adhesion-increasing agent by a device for dispensing adhesion-increasing agent. These are optionally wheels which are assigned to the device for dispensing adhesion-increasing agent, for example, the next two wheels or the next five wheels. The calculating unit is in this case adapted to determine the ratio of the wheel speed or the rotational wheel speed of at least one further wheel and the speed of the rail vehicle and/or the ratio of the wheel acceleration of at least one further wheel and the acceleration in the longitudinal direction of the rail vehicle and/or the ratio between the target torque acting on the wheel and the actual torque of at least one further wheel, and likewise to take this calculation result into consideration for controlling the dispensing of adhesion-increasing agent by the device for dispensing adhesion-increasing agent.

In this way it is ensured that the dispensed adhesion-increasing agent on the rail reaches the next wheels that run over the dispensed adhesion-increasing agent. Therefore, the dispensing of adhesion-increasing agent can be locally controlled, that is to say that intervention occurs at the wheel or wheels at which reduced frictional adhesion can be observed, and adhesion-increasing agent is correspondingly dispensed. Consequently, adhesion-increasing agent need not be dispensed along the entire length of the rail vehicle, which saves adhesion-increasing agent and also improves the frictional adhesion at quite specific wheels.

Optionally provided in the system for each device for dispensing adhesion-increasing agent is a measuring unit for measuring the dispensing of adhesion-increasing agent, which measures the current actual dispensing of adhesion-increasing agent at a device for dispensing adhesion-increasing agent. By monitoring this parameter, the control of the actual dispensing rate can take place correspondingly, and deviations or malfunctions of the corresponding device for dispensing adhesion-increasing agent can be avoided.

Optionally, at least two devices for dispensing adhesion-increasing agent (one per rail), if not even a number of devices for dispensing adhesion-increasing agent (along the vehicle), are provided on a rail vehicle. These devices are all locally controlled, and the data respectively of a wheel that is assigned to the respective device for dispensing adhesion-increasing agent are taken into consideration. Data of a number of wheels may also be used for controlling the dispensing of adhesion-increasing agent of a device for dispensing adhesion-increasing agent.

Optionally also provided is a data transfer unit, which allows the respective calculating units to communicate with one another and to exchange measurement results and calculation results. Therefore, one or more controlled devices for dispensing adhesion-increasing agent, in which parameters are exchanged by way of the data transfer unit, for example, a data bus, may be provided over the length of the vehicle.

If it is then found that a device for dispensing adhesion-increasing agent has reached its maximum dispensing rate of adhesion-increasing agent, even though according to the calculation by the calculating unit or the control actually more adhesion-increasing agent should be discharged, further devices for dispensing adhesion-increasing agent at another location of the rail vehicle may be activated by way of the data transfer unit in order that correspondingly more adhesion-increasing agent can be dispensed at these further devices.

If a calculating unit therefore finds that the dispensing rate of adhesion-increasing agent calculated for one device for dispensing adhesion-increasing agent lies above the maximum dispensing rate of adhesion-increasing agent, for example, the dispensing rate that is technically possible as a maximum, the deviation between the actually calculated dispensing rate of adhesion-increasing agent and the maximum dispensing rate of adhesion-increasing agent can be communicated by way of the data transfer unit to another calculating unit, in order that the latter correspondingly supplements the deviation in addition to the dispensing rate of adhesion-increasing agent ascertained by this calculating unit for the other device respectively for dispensing adhesion-increasing agent, and more adhesion-increasing agent is correspondingly discharged there—but only as long as the maximum dispensing rate of adhesion-increasing agent of this device for dispensing adhesion-increasing agent is not exceeded. Otherwise, yet another device for dispensing adhesion-increasing agent may also be activated—or the deviation between the actually calculated dispensing rate of adhesion-increasing agent and the maximum dispensing rate of adhesion-increasing agent of the one device for dispensing adhesion-increasing agent may be shared between a number of further devices for dispensing adhesion-increasing agent.

This is also of advantage if a device for dispensing adhesion-increasing agent fails or there is no longer any adhesion-increasing agent in it.

Furthermore, upper and/or lower limit values may be specified for controlling the dispensing of adhesion-increasing agent by one or more device(s) for dispensing adhesion-increasing agent, and, when these limits are exceeded or not reached, the dispensing of adhesion-increasing agent by the dispensing device(s) for adhesion-increasing agent can be increased or reduced. Therefore, a range of the frictional adhesion in which no intervention in the dispensing of adhesion-increasing agent takes place exists. This makes the control easier and less complex, and there is only a reaction if the frictional adhesion is too low and more adhesion-increasing agent must urgently be dispensed, or the frictional adhesion is too high and consequently adhesion-increasing agent can be saved.

Disclosed embodiments also relate to a method for controlling the dispensing of adhesion-increasing agent of a rail vehicle which comprises the following operations:

a) detecting the speed and/or the acceleration in the longitudinal direction of a rail vehicle;

b) detecting the wheel speed and/or the rotational wheel speed or wheel acceleration of a wheel of a rail vehicle and/or the actual wheel torque acting on a wheel;

c) determining the ratio of the wheel speed or rotational wheel speed of the wheel and the speed of the rail vehicle and/or the ratio of the wheel acceleration of the wheel and the acceleration in the longitudinal direction of a rail vehicle and/or the ratio of the actual torque acting on the wheel and the target torque,

d) controlling the dispensing of adhesion-increasing agent by a device for dispensing adhesion-increasing agent in dependence on the ratio obtained in step c), the ratio for the wheel determined in step c) being used for the control.

The measured wheel acceleration is optionally the angular acceleration of the wheel.

Optionally, a number of wheels, which are, for example, provided in the direct vicinity of the respective device for dispensing adhesion-increasing agent, are taken into consideration for each device for dispensing adhesion-increasing agent. Consequently, a device for dispensing adhesion-increasing agent is provided for a specific number of wheels.

Optionally, at least two devices for dispensing adhesion-increasing agent that are provided on a rail vehicle are also connected to a data transfer unit which is adapted to exchange operational and control parameters. This data transfer unit is optionally a data bus.

If then a maximum dispensing rate of adhesion-increasing agent (that is to say either a technically possible maximum dispensing of adhesion-increasing agent or a specification that is set, for example, on the basis of the train speed) is set for two devices for dispensing adhesion-increasing agent, and a calculating unit finds that the dispensing rate of adhesion-increasing agent calculated for the respective device for dispensing adhesion-increasing agent lies above the maximum dispensing rate of adhesion-increasing agent, the deviation between the calculated dispensing rate of adhesion-increasing agent and the maximum dispensing rate of adhesion-increasing agent can be communicated by way of the data transfer unit to another calculating unit, which controls another device for dispensing adhesion-increasing agent. Then, this deviation is correspondingly supplemented in addition to the dispensing rate of adhesion-increasing agent ascertained by this calculating unit for the other device respectively for dispensing adhesion-increasing agent, as long as the maximum dispensing rate of adhesion-increasing agent of this device for dispensing adhesion-increasing agent is not exceeded

In the method according to the disclosed embodiments, optionally upper and lower limit values for specific parameters can be stored or can be specified and, when these limits are exceeded or not reached, the dispensing of adhesion-increasing agent by the device for dispensing adhesion-increasing agent can be correspondingly increased or reduced.

Here, specific tolerance ranges in which the frictional adhesion between the wheel and the rail is tolerance may then be stored, but any departure from this range has the effect that adhesion-increasing agent is correspondingly dispensed. At the same time, in the case in which a required level of frictional adhesion has been reached, the dispensing of adhesion-increasing agent can keep being reduced, in order nevertheless to reach a specified limit value.

In accordance with the disclosed embodiments, individually adaptable control of the dispensing rate of the adhesion-increasing agent can be realized, in particular locally adaptable control of the dispensing rate of adhesion-increasing agent. Furthermore, with this system, control of the amount of adhesion-increasing agent that is optimized in terms of drive, deceleration or consumption can be realized.

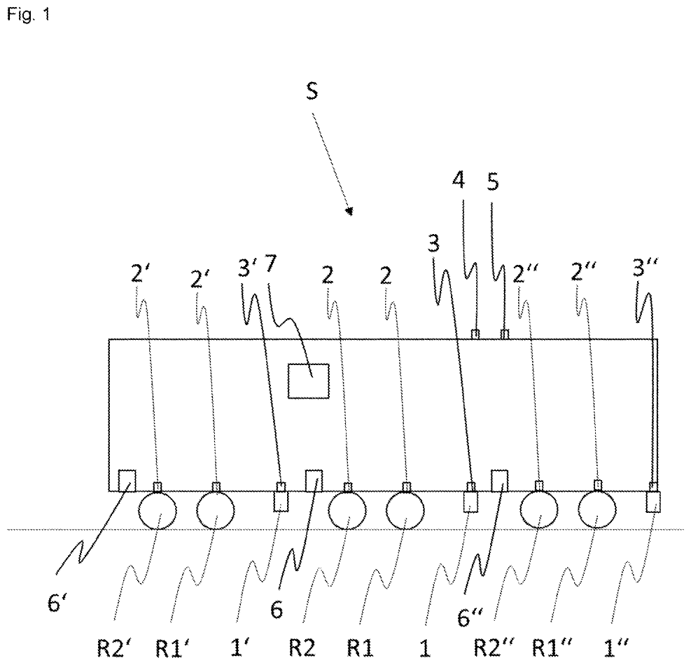

Shown in FIG. 1 is a rail vehicle S, on which a number of wheels R1, R2; R1′, R2′; R1″, R2″ are provided—here there are always two wheels correspondingly arranged close to one another. Arranged in the vicinity of the pairs of wheels R1, R2; R1′, R2′; R1″, R2″ there is respectively a device 1, 1′, 1″ for dispensing adhesion-increasing agent. Fastened directly to it there is in each case a measuring unit for measuring the dispensing of adhesion-increasing agent 3, 3′, 3″. Arranged on each wheel R1, R2; R1′, R2′; R1″, R2″ is a corresponding wheel speed sensor 2, 2′, 2″. Also provided in the direct vicinity of each pair of wheels is a calculating unit 6, 6′, 6″. Provided in all cases on the vehicle are also a measuring unit 4 for the vehicle speed and a measuring unit 5 for the vehicle acceleration in the longitudinal direction of the vehicle and a data transfer unit 7.

In the case where the rail vehicle is moving to the right, the wheels R1 and R2 are assigned the device 1 for dispensing adhesion-increasing agent (the wheels R1′ and R2′ are correspondingly assigned the device 1′ for dispensing adhesion-increasing agent and the wheels R1″ and R2″ are correspondingly assigned the device 1″ for dispensing adhesion-increasing agent).

However, this is not a fixed assignment—in the case where the rail vehicle is moving to the left, the wheels R1 and R2 may be assigned the device 1′ for dispensing adhesion-increasing agent (the wheels R1″ and R2″ may correspondingly be assigned the device 1 for dispensing adhesion-increasing agent).

The calculating units 6, 6′, 6″ therefore respectively calculate and control locally the dispensing of adhesion-increasing agent of the devices for dispensing adhesion-increasing agent 1, 1′ and 1″.

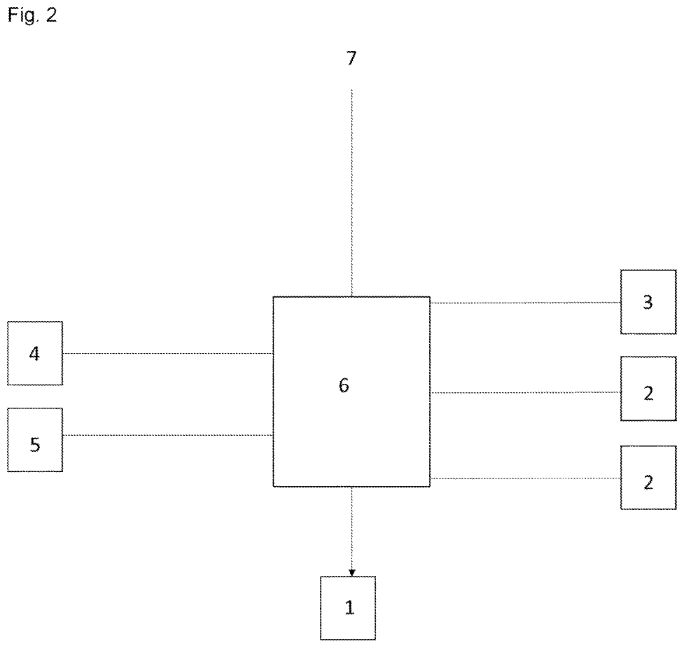

Shown in FIG. 2 are the input parameters and dispensing parameters in a calculating unit 6. In all cases, the measured values of the measuring unit 4 for the vehicle speed and of the measuring unit 5 for the vehicle acceleration in the longitudinal direction of the vehicle are inquired. The calculating unit 6 also communicates with the data transfer unit 7, if information of other calculating units 6′ plays a role here. Furthermore, the calculating unit 6 inquires data of the two wheel speed sensors 2, 2 and of the measuring unit for measuring the dispensing of adhesion-increasing agent 3. The calculating unit 6 then correspondingly performs a control, and the dispensing rate of the device for dispensing adhesion-increasing agent 1 is correspondingly calculated. This value is then output to the device for dispensing adhesion-increasing agent 1.

Examples of control which can be performed with the system according to the disclosed embodiments and the method according to the disclosed embodiments are as follows:

For example, optimizing of the acceleration or deceleration behavior may be performed. The dispensing rate of adhesion-increasing agent which is provided by a device for dispensing adhesion-increasing agent 1, 1′, 1″ is increased up to the maximum permissible or possible dispensing rate, until the frictional adhesion of all the wheels R1, R2, . . . , Rn has been improved in such a way that the by the measuring unit 5 for the train acceleration or deceleration observed in the longitudinal direction of the vehicle lies within the toleranced or reduced capability in comparison with the dry rail.

On the other hand, the consumption of adhesion-increasing agent may also be optimized. The system or method according to the disclosed embodiments can then individually reduce the applied amount of adhesion-increasing agent to a greatly reduced minimum. After reaching the required frictional adhesion, the dispensing rate is then reduced until the actual level of the frictional adhesion falls below the required level again—that is to say the level that is at least required to ensure safe accelerating and braking without wheels being damaged. If the driving or braking effect falls too much, the dispensing rate of adhesion-increasing agent is then increased again.

The presently disclosed embodiments are not restricted to the embodiments represented.

In the embodiment shown in FIGS. 1 and 2, wheel speed sensors are respectively shown—but wheel acceleration sensors 2a or wheel torque sensors 2b could be provided equally well—then a ratio of the wheel acceleration and the acceleration in the longitudinal direction of a rail vehicle (S) and/or the ratio of the actual torque acting on the wheel (R1) and the target torque of the wheel (R1) would be ascertained.

Furthermore, the dispensing rates for individual devices 1, 1′, 1″ for dispensing adhesion-increasing agent may also be calculated by a central calculating unit.

The disclosed embodiments comprise an apparatus and a method for controlling the dispensing of adhesion-increasing agent of a rail vehicle S with at least one device 1 for dispensing adhesion-increasing agent, which is assigned to a wheel R1 of a rail vehicle.

The system also comprises at least one wheel speed sensor 2 and/or wheel acceleration sensor 2a and/or wheel torque sensor 2b, which measures the wheel speed or the rotational wheel speed and/or the wheel acceleration and/or the wheel torque acting on the wheel of a specific wheel. Also provided is a measuring unit 4, 5, which determines the vehicle speed and/or the acceleration in the longitudinal direction of the vehicle of the entire rail vehicle. A calculating unit 6 is adapted to ascertain the ratio of the wheel speed or the rotational wheel speed of the wheel and the speed of the rail vehicle and/or the ratio of the wheel acceleration and/or the acceleration in the longitudinal direction of the rail vehicle and/or the ratio between the target torque acting on the wheel and the actual torque. This at least one ratio is considered, in particular how it changes. The control of the dispensing of adhesion-increasing agent by the device 1 for dispensing adhesion-increasing agent takes place on the basis of the changing of this at least one ratio.

### LIST OF DESIGNATIONS

S Rail vehicle
R1, R2, Rn Wheel
1, 1′, 1″ Device for dispensing adhesion-increasing agent
2 Wheel speed sensor
2a Wheel acceleration sensor
2b Torque sensor
3 Measuring unit for measuring the dispensing of adhesion-increasing agent
4 Measuring unit for the vehicle speed
5 Measuring unit for the acceleration in the longitudinal direction of the vehicle
6 Calculating unit
7 Data transfer unit

1. An apparatus for controlling dispensing of adhesion-increasing agent of a rail vehicle, the apparatus comprising:
at least one device configured to dispense adhesion-increasing agent, which is assigned to a wheel of a rail vehicle;
at least one wheel speed sensor, which measures the wheel speed or rotational wheel speed of the wheel and/or at least one wheel acceleration sensor, which measures the wheel acceleration of the wheel, and/or at least one torque sensor, which measures the torque acting on the wheel;
a measuring unit, which determines the vehicle speed, and/or a measuring unit, which is intended to determine the vehicle acceleration in the longitudinal direction of the vehicle;
a calculating unit, which is configured to ascertain a ratio of the wheel speed or rotational wheel speed of the wheel and a speed of the rail vehicle and/or a ratio of the wheel acceleration of the wheel and the acceleration in the longitudinal direction of a rail vehicle and/or the ratio of the actual torque acting on the wheel and the target torque, and to control the amount of adhesion-increasing agent dispensed by the device for dispensing adhesion-increasing agent based on the calculation result.

2. The apparatus of claim 1, wherein the calculating unit is configured to determine the ratio of the wheel speed of at least one further wheel and the speed of the rail vehicle and/or the ratio of the wheel acceleration of at least one further wheel and the acceleration in the longitudinal direction of a rail vehicle and/or the ratio of the actual wheel torque acting on the wheel and the target wheel torque of at least one further wheel, and to take this calculation result into consideration for controlling the dispensing of adhesion-increasing agent by the device for dispensing adhesion-increasing agent.

3. The apparatus of claim 1, wherein at least two devices for dispensing adhesion-increasing agent are provided for each rail vehicle, and wherein, for controlling the at least two devices for dispensing adhesion-increasing agent, the calculating unit takes into consideration in each case at least the data respectively of one wheel is assigned to each of the respective devices for dispensing adhesion-increasing agent, and
wherein the data of a plurality of wheels are used for controlling each device for dispensing adhesion-increasing agent.

4. The apparatus of claim 3, further comprising a data transfer unit configured to enable communication by the calculating units to communicate and also to exchange measurement results and calculation results.

5. The apparatus of claim 4, wherein the maximum dispensing rate of adhesion-increasing agent is set for the at least two devices for dispensing adhesion-increasing agent,
and, if at least one calculating unit finds that the dispensing rate of adhesion-increasing agent calculated for the respective device for dispensing adhesion-increasing agent is above the set maximum dispensing rate for adhesion-increasing agent, the calculating unit is configured to communicate the deviation between the calculated dispensing rate of adhesion-increasing agent and the maximum dispensing rate of adhesion-increasing agent by way of the data transfer unit to another calculating unit, wherein the other calculating unit is configured to correspondingly supplement the deviation of the dispensing rate of adhesion-increasing agent ascertained by this other calculating unit for the other device respectively for dispensing adhesion-increasing agent, as long as the maximum dispensing rate of adhesion-increasing agent of this device for dispensing adhesion-increasing agent is not exceeded.

6. The apparatus of claim 1, wherein upper and/or lower limit values are specified for controlling the dispensing of adhesion-increasing agent by at least one device for dispensing adhesion-increasing agent,
and, in response to the limits being exceeded or not reached, the dispensing of adhesion-increasing agent by the device for dispensing adhesion-increasing agent is increased or reduced.

7. The apparatus of claim 1, further comprising a measuring unit for measuring the current actual dispensing of adhesion-increasing agent of the device.

8. A method for controlling dispensing of adhesion-increasing agent of a rail vehicle, the method comprising:
detecting speed and/or acceleration in the longitudinal direction of a rail vehicle;
detecting wheel speed and/or rotational wheel speed or wheel acceleration of a wheel of a rail vehicle and/or the actual wheel torque acting on the wheel;
determining a ratio of the wheel speed or rotational wheel speed of the wheel and the speed of the rail vehicle and/or a ratio of the wheel acceleration of the wheel and the acceleration in the longitudinal direction of a rail vehicle and/or a ratio of the actual torque acting on the wheel and the target torque,
controlling the dispensing of adhesion-increasing agent by a device for dispensing adhesion-increasing agent based on the determined ratio of the wheel speed or rotational wheel speed of the wheel and the speed of the rail vehicle and/or the ration of the wheel acceleration of the wheel and the acceleration in the longitudinal direction of the rail vehicle and/or the ratio of the actual torque acting on the wheel and the target torque.

9. The method of claim 8, wherein, during control of the dispensing of adhesion-increasing agent, at least one further ratio of the determined ratios, which was determined for one or further wheels, is/are additionally used for controlling the dispensing of adhesion-increasing agent by a device for dispensing adhesion-increasing agent.

10. The method of claim 8, wherein a device for dispensing adhesion-increasing agent is provided for a specific number n of wheels.

11. The method of claim 8, wherein at least two devices for dispensing adhesion-increasing agent, which are provided on a rail vehicle, are connected to a data transfer unit and exchange operational and control parameters,
wherein the data transfer unit is preferably a data bus.

12. The method as claimed in claim 11, wherein a maximum dispensing rate of adhesion-increasing agent is set respectively for the at least two devices for dispensing adhesion-increasing agent,
and, if a calculating unit finds that the dispensing rate of adhesion-increasing agent calculated for the respective device for dispensing adhesion-increasing agent lies above the maximum dispensing rate of adhesion-increasing agent, the deviation between the calculated dispensing rate of adhesion-increasing agent and the maximum dispensing rate of adhesion-increasing agent is communicated by way of the data transfer unit to another calculating unit, in order that the latter correspondingly supplements the deviation in addition to the dispensing rate of adhesion-increasing agent ascertained by this calculating unit for the other device respectively for dispensing adhesion-increasing agent, as long as the maximum dispensing rate of adhesion-increasing agent of this device for dispensing adhesion-increasing agent is not exceeded.

13. The method of claim 8, wherein upper and/or lower limit values are specified for controlling the dispensing of adhesion-increasing agent by the device for dispensing adhesion-increasing agents, and, in response to these limits being exceeded or not reached, the dispensing of adhesion-increasing agent by the device for dispensing adhesion-increasing agent is increased or reduced.

14. The method of claim 8, wherein the current actual dispensing of adhesion-increasing agent of the device for dispensing adhesion-increasing agent is also measured by a measuring unit for measuring the dispensing of the adhesion-increasing agent.
